(19) United States
(12) Patent Application Publication
(10) Pub. No.: US 2009/0177526 A1
(43) Pub. Date: Jul. 9, 2009

(54) System, method and computer program for selecting an information provider

(75) Inventors: Janne Aaltonen, Turku (FI); Sami Saru, Turku (FI); Timo Ahopelto, Helsinki (FI); Jouni Malinen, Espoo (FI)

Correspondence Address: FRISHAUF, HOLTZ, GOODMAN & CHICK, PC, 220 Fifth Avenue, 16TH Floor, NEW YORK, NY, 10001-7708, US

(73) Assignee: CVON Innovations Ltd., London (GB)

(21) Appl. No.: 12/290,140

(22) Filed: Oct. 28, 2008

Related U.S. Application Data
(60) Provisional application No. 61/010,215, filed on Jan. 7, 2008.

(30) Foreign Application Priority Data
Feb. 19, 2008 (GB) 0802989.4

(51) Int. Cl. G06F 17/30

(52) U.S. Cl. 705/10

(57) ABSTRACT

System, method and computer program for enabling use of a plurality of information providers in order to obtain content and/or messages for use by a service provider. Data relating to a user requesting a service from the service provider and/or relating to resource requirements relating to messages provided by the information providers is obtained and based thereon, one of the information providers is selected to provide a message or content to be associated with the service being requested by the user.

### CROSS-REFERENCE TO RELATED APPLICATIONS

This application claims priority under 35 USC 119 of U.S. Provisional Patent Application No. 60/010,215 filed Jan. 7, 2008 and U.K. Patent Application No. GB 0802989.4 filed Feb. 19, 2008, the entire disclosure of each of which is incorporated herein by reference.

### FIELD OF THE INVENTION

The present invention relates generally to systems, methods and computer programs for selecting from a plurality of information providers in order to select content, or messages, for transmission to a user device. Each information provider has access to a plurality of content inventories, each of which content inventory is associated with one or more defined characteristics for use in selecting content from a respective inventory, such that any given information provider acts as a broker in respect of content available from the respective inventories. Most preferably the content, or messages, are selected for delivery to a user's terminal in association with a service requested by the user from an Internet service provider.

### BACKGROUND INFORMATION

Usage of cellular or mobile telephones and other devices, hereinafter considered as mobile terminals, is very popular and common. The popularity of mobile terminals has enabled their use, along with related infrastructure, as a media for providing mobile marketing, i.e., advertisements to the users of the mobile terminals.

One particular method for providing advertisement to users of mobile terminals is to add a banner type of advertisement in a Web or Wireless Application Protocol (WAP) page accessed by the user (although this technique of providing an advertisement is not limited to mobile terminals and is also applicable to fixed terminals). Advertisement revenues of such banner advertisements are typically based on either impressions, i.e., the number of times the advertisement has been potentially seen (in practice downloaded) by users of mobile terminals, or based on a “click through”, i.e., how many times the advertised item has been selected by users of the mobile terminals. Revenue models relating to performance and effectiveness of the click through advertisement technique may be implemented, i.e., data about actual purchasing of advertised products or services relative to the number of times the advertisements have been viewed can be obtained and analyzed to optimize the advertising campaign.

Another method for providing advertisements to users' terminal is based on users initiating search and other information queries. In these situations, one or more advertisements may be delivered to each user in connection with the results of the search or information query, and which may relate to the search being performed or information being sought.

In the advertising industry, there are information providers that help service providers of web pages and WAP pages place advertisements in or in association with the web and WAP pages. Such information providers can target advertisements for advertisers based on, for example, recipient profiles. An exemplary broker is the AdSense™ service provided by Goggle™ which offers service providers the ability to place advertisements that are relevant to the content of a web page for recipients viewing the web page. Thus, the content of the web page is analyzed and an appropriate advertisement is selected based thereon. Typically, there may be a side bar or banner for displaying the advertisements to recipients that are visiting the service provider that has AdSense™ implemented. A similar advertisement service is also offered by Yahoo! Inc. In addition, there are information providers that offer service providers the ability to implement banner advertisements on Web and WAP pages for their own services.

In view of the presence of several information providers in the market place, a service provider is confronted with various possibilities for placing or embedding advertising into their Web or WAP pages or other online services. In order to deliver superior user experience and maximize revenues, the service provider would need to work with multiple information providers, since any single broker might not be able to offer advertisements that are in line with the needs of the recipients, i.e., have suitable advertisements in their inventory. This might give rise to negative recipient experiences and lower profits for the web or WAP page service provider. As such, Web and WAP service providers invariably run advertisements in association with multiple information providers at their web site. This is disadvantageous as it requires the service provider to independently assess the benefits and drawbacks of working with each information provider and attempt to find its best course of action for conducting an advertising campaign using one or more of the information providers.

### SUMMARY OF THE INVENTION

The present invention is directed at least in part to a system, method and computer program as set forth in the claims. The system, method and computer program enable service providers to use more than one information provider to secure content for their web sites and web pages, and potentially for the same or overlapping content inventory and/or even the same content placement on the page of the service. This enables the service provider to automatically select an information provider that is likely to have the best fit relative to the intended recipient, e.g., the selection is based on recipients' profiles including parameters of how the recipient is accessing the service, such as capabilities of the utilized terminal or connection speed.

Another embodiment of the present invention set forth in the claims is directed at least in part to a system, method and computer program for enabling message providers to conduct content delivery campaigns using multiple information providers which seek to utilize network resources most effectively by their selection and transmission of content from the respective content inventories.

Yet other embodiments of the present invention set forth in the claims are directed to a system, method and computer program, which enable use of a plurality of internet service providers in order to provide web-based services for users upon request by each user. Criteria are established to enable selection of a particular one of the internet service providers to provide the service to the user.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic of an exemplifying embodiment of an architecture in which a content management system and method in accordance with the invention can be used.

FIG. 2 shows one manner in which an information provider is selected to associate content, or a message, with a communication, e.g., a web or WAP page, being delivered to a user of a mobile terminal in accordance with the invention.

FIG. 3 shows a web page modified to show content selected by a system or method in accordance with the invention.

FIG. 4 shows an example of the variable selection of an Internet service provider in a system and method in accordance with the invention.

FIG. 5 is a schematic of an exemplifying embodiment of an architecture in which a service provider is selected to provide a service to a user upon request in accordance with the invention.

### DETAILED DESCRIPTION

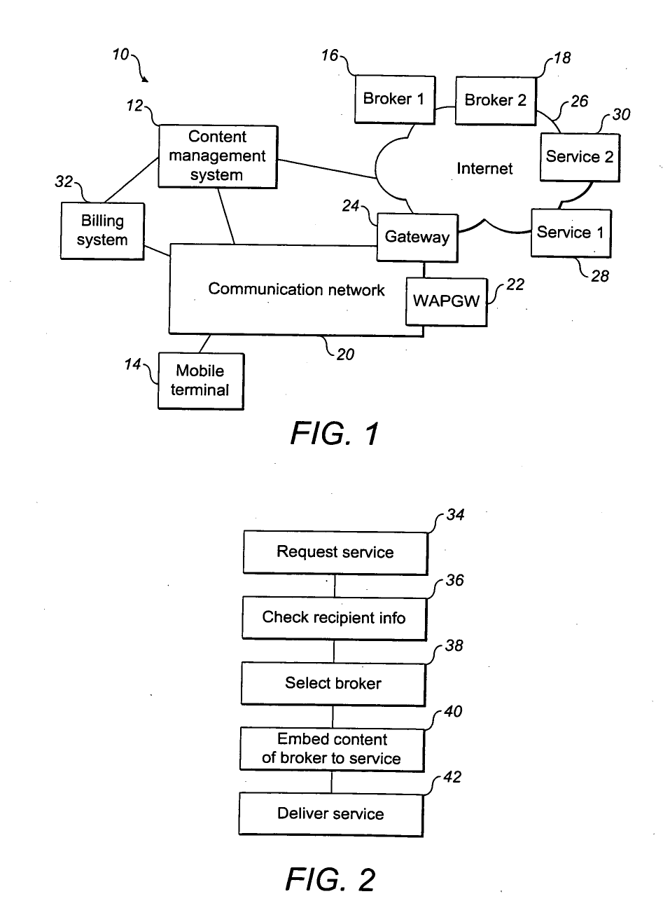

Referring to the accompanying drawings wherein the same reference numerals refer to the same or similar elements, FIG. 1 shows an exemplifying, non-limiting embodiment of an architecture in which an information provider, such as an information provider selection system, can be used in accordance with the invention. The information provider selection system is designated generally as 10 and may be implemented for the mobile domain. However, although the discussion below refers to the application of the invention to the mobile domain, the mobile domain has been selected as an example of the application of the invention and the invention can be applied also to the Internet, broadcast media, traditional media, printed media, radio, television, among others.

The system 10 includes one or more content providers such as advertisers, defined to include any and all entities or individuals that want to provide information relating to products or services to customers interacting with the mobile domain, and a content management system 12 that is operated by, for example, a content delivery company.

Content providers such as advertisers can refer to a brand owner, a service provider, an advertisement agent, a merchant or any other party that wants to provide content to recipients. The content can be commercial, such as a product or service promotion, or non-commercial, such as a general information service notification. A content provider can also be a store having a physical presence, an on-line store and the like, which sell or deliver goods and provide services directly to users ordering via their mobile terminals 14 (only one of which is shown in FIG. 1).

Typically, the operator of the content management system 12 is a company in the business of delivering advertisements from several content providers, i.e., it is the intermediary between advertisers and the operators of the advertisement distribution channels. Operation of the content management system 12 is typically managed over an Internet interface.

Each content provider is able to access an interface from a plurality of information providers 16, 18. Although the interfaces from one information provider to another may vary, each interface preferably includes tools for each content provider to define rules of their campaign, i.e., to enable them to tailor the campaign to their specific desires. This may include reserving, programming and/or booking an advertising campaign. Parameters which are determined include, but are not limited to, the time period or periods when to send messages, the duration of the campaign, the target group or groups, demographics of the target group(s), the format or type of message, the target price level or cost per message or for the campaign in its entirety, the target feedback level of the message, the sociological background of the target audience, interests as declared by the target group(s), demographics of the target group(s) including, for example, age, sex and income level(s), keywords related to the message, a type of Web or WAP site to associate with the message, target telephone type, location of the recipient, etc. A content provider may also be able to define a set of keywords related to the addressing of advertisements to communication sessions between users and/or between users and content services.

In addition to determining the rules, each content provider typically provides one or more actual advertisements via the interface to the information providers 16, 18 in the form of data, text, pictures, video, audio, flash animations, Portable Document Format (PDF) documents, links, television content, videos, Hypertext Markup Language (HTML), Extensible markup language (xml), Extensible Hypertext Markup Language (xHTML), Wireless Application Protocol (WAP) pages, web pages, etc., or any digital content compatible for reception and display by the users' mobile terminal 14.

Each interface is therefore the information provider's 16, 18 content management system in that it receives and manages content in inventories maintained by the information provider 16, 18.

The preferences, settings, advertisements, messages, texts, figures, keywords and other rules set by the advertisers relating to the delivery and tagging of communications involving the advertisements may be stored in one or more databases resident in or otherwise associated with each information provider 16, 18.

In one embodiment, there is an auction of allocatable content and/or messages to be sent to the users of the mobile terminals 14, which auction is coordinated by each information provider 16, 18, if desired. As such, content providers can participate in an auction and bid for predetermined advertising blocks.

Mobile terminal 14 is arranged to use a communications network 20 to communicate with other elements of the system 10 described below. Communications network 20 can utilize any cellular network technologies that include, but are not limited to, Global System for Mobile Communications (GSM), Wideband Code Division Multiple Access (WCDMA), Code Division Multiple Access (CDMA) and General Packet Radio Service (GPRS). In addition to traditional cellular networks, local area networks such as Wireless Local area networks (WLAN), BlueTooth (BT) and other technologies such as Worldwide Interoperability for Microwave Access (WiMax), Broadcasting over Digital Video Broadcasting-Handheld (DVB-H), Integrated Services Digital Broadcasting-Terrestrial (ISDB-T), (Digital Multimedia Broadcasting) DMB or broadcasting over cellular can be used, e.g., to deliver advertisements, Internet, WAP data and communications as discussed below. The communications network 20 can also be a generic Internet access network using any data transport methods. Moreover, the communications network 20 may be any cellular, broadcast, wide area, local area or Internet network. Communications network 20 can also be a combination of different communications networks, i.e., a hybrid network, such as a Wireless Local Area Network (WLAN) and a Wideband Code Division Multiplex (WCDMA) network. Using the foregoing network(s), the advertisements from advertisers can be Short Message Service (SMS) messages, Multimedia Message Service (MMS) messages, WAP Push, Web pages, or any digital object.

Subscribers to the mobile telephone operator using the mobile terminals 14 can use the same communications network or another communications network as the communications network 20 being used to deliver advertisements from advertisers via the content management system 12, i.e., a hybrid network is possible.

The mobile terminals 14 may be any form of mobile terminal such as a mobile telephone, a smart telephone, a multimedia computer, a personal digital assistant (PDA), a laptop computer, a multimedia computer, or a personal computer. Further, the mobile terminals 14 may be connected to the communications network 20 by means of a wireless and/or wired communication link. For a GSM network, the link between the mobile terminals 14 and the communications network 20 is wireless. At a minimum, the mobile terminals 14 have the capability to communicate with one or more different types of communications networks and have messaging capabilities in the form of a messaging client system such as a short message service (SMS) client system, an e-mail client system, or a multimedia message service client system embedded in the mobile terminal 14. Additionally, mobile terminals 14 may also include a browser to access Web and/or WAP services.

An advertisement can be delivered to the users' mobile terminals 14 via the communications network 20. The communications network 20 may be any cellular, broadcast, wide area, local area or Internet network. For example, FIG. 1 shows a typical layout of a cellular communications network 20 which includes network elements including a WAP Gateway (WAPGW) 22 and an Internet gateway 24. The communications network 20 is connected to the Internet 26 via gateway 24 and enables access to target Internet sites or services of Internet service providers 28, 30 for the users of the mobile terminals 14. The WAPGW 22 can enable wireless access to the Internet 26 or dedicated WAP services, e.g., mobile services. The Internet service providers 28, 30 may be, for example, providers of web and/or WAP pages.

To obtain Internet services from service providers 28, 30, a user of the mobile terminal 14 must access the WAPGW 22 and/or Internet gateway 24 via the communications network 20 which in turn is connected to the content management system 12, and this allows for the modification of Web or WAP pages, or other requested services, being requested by the user of the mobile terminal 14 from the Internet service providers 28, 30. Specifically, one or more of the advertisements stored in a database in content management system 12, in a database maintained by one of the information providers 16, 18 or in another database accessible by the content management system 12, can be added or inserted into, or otherwise associated with, Web and WAP pages being provided to the mobile terminal 14, as well as into communication sessions using the Internet 26. The manner in which this is performed in accordance with the invention is described below.

In one embodiment, base stations (BS) and other elements, interfaces and functional components necessary to operate, manage and control communications network 20 may be provided, such as a Short Message Service Center (SMSC) and a Multimedia Message Service Center (MMSC).

System 10 also includes a billing system 32 coupled to the content management system 12 and/or the communications network 20 or specific parts thereof, and may be arranged to monitor and/or meter usage and payments of or for the advertisements being delivered to each mobile terminal 14 by the content management system 12. The billing system 32 may be a real-time billing system or a close-to-real-time billing system.

In accordance with the invention, the content management system 12 preferably contains profile information relating to the users of the mobile terminals 14 such as their browsing and/or purchasing behavior or patterns, the likelihood of the users responding to certain types of advertisements, their preferences about search service providers, and/or their preferences about “trusted” advertisement information providers, i.e., which advertiser is believed with respect to claims made about their advertised product or service. Moreover, the content management system 12 may include information about placement of advertisements by multiple information providers 16, 18 such as price information relating to advertisements from one or more of the information providers 16, 18, i.e., how much each information provider 16, 18 charges to place content on, or associate messages with, a web or WAP page. This information may be stored in one or more databases associated with, resident within or otherwise accessible to the content management system 12. A computer program in the content management system 12 can maintain the database(s) or enable access to the database(s) when needed. The price information can be derived from network resource usage requirements associated with the delivery of the content/messages in association with the web or WAP pages.

The content management system 12 is also arranged to obtain information about when the users of the mobile terminals 14 are accessing Internet service providers 28, 30 via the communications network 20. This type of information may be stored as a set of data including, for example, a Mobile Subscriber Identity Number (MSISDN), IMSI, user name, IP address, MAC address, browser type, terminal type. Additionally or alternatively, part or all of this information may be obtained from the Internet service providers 28, 30 being accessed by the user of the mobile terminal 14, by the WAPGW 22 and/or Internet gateway 24 being used by the user of the mobile terminal 14 to access the Internet service providers 28, 30, and/or by the billing system 32. Basically, any part of the system 10 may be used to obtain the type of information described above, and thereby determine when the user of the mobile terminal 14 is using the Internet and requesting a service from the Internet service providers 28, 30.

In accordance with the invention, when the requested service is determined to one for which content such as an advertisement may be associated, the content management system 12 determines which information provider 16, 18 will provide an advertisement to be associated with a web or WAP page being transmitted from the Internet service provider 28, 30 to the user's mobile terminal 14 to be displayed thereon. This initial determination may be made by the content management system 12 or another part of the system 10 which monitors communications from the user's mobile terminal 14.

Several different ways are envisioned to enable selection of one of the available information providers 16 or 18 to provide an advertisement to be associated with a requested service being provided by the Internet service providers 28, 30.

In one embodiment, the content management system 12 provides information to Internet service providers 28, 30 to enable the Internet service providers 28, 30 themselves to select which information provider 16 or 18 will provide an advertisement to be associated with a web or WAP page being transmitted from the Internet service provider 28, 30 to the user's mobile terminal 14 to be displayed thereon. Thus, only information gathered and stored by the content management system 12 relating to the user and/or price information about the information providers 16, 18 is provided to the Internet service providers 28, 30 thereby allowing a computer program at the Internet service providers 28, 30 to determine which information provider 16, 18 to use to obtain an advertisement to be associated with a web or WAP page being provided by the Internet service provider 28, 30. Once an information provider 16 or 18 is selected, the information provider 16 or 18 may be directed by the content management system 12 to provide an advertisement to the Internet service provider 28, 30 which is then directed to include the advertisement in a communication to the user's mobile terminal with the requested service, e.g., associate the advertisement with a web or WAP page.

Alternatively, the user of the mobile terminal 14 is not provided with an option to obtain web or WAP pages from multiple Internet service providers 28, 30 but rather the content management system 12 selects an Internet service provider 28 or 30 for the user. This selection may be based on the user's profile, usage of network resources as assessed by the operator of the user's mobile terminal 14, the expected revenue for the advertisement system operator or the Internet service provider, all of which information is contained in one or more databases accessible by the content management system 12. In this case, consideration may be given to select a particular Internet service provider based on the potential to offset the resource usage requirements for certain data and/or data services using revenues received from the selection. Thus, the user's choice of Internet service providers would be restricted, but the user would obtain subsidized or even free services.

The selection of which Internet service provider to use may also be based in part of the presence of benefits to the users, e.g., as direct money reimbursement, free voice services, free communication services etc.

An example of the application of the information provider selection technique described above will be explained with reference to FIG. 2.

For this example, it is assumed that information provider 16 has been able to attract advertisers that value recipients accessing services from area A more than recipients from area B while information provider 18 has attracted advertisers that value recipients accessing services from area B more than recipients from area A. For this example, it is also assumed that click-through revenues to an Internet service provider are 10 units for recipients from area A and 5 units for recipients from area B from information provider 16, while information provider 18 offers the same Internet service provider 7 units to recipients from area B and 4 units from area A.

The content management system 12, with knowledge of the different prices being paid to the Internet service provider by information providers 16 and 18, would maximize revenue for the Internet service provider. Therefore, when a recipient from area A connects to the Internet service provider and requests a service 34, the content management system 12 would check the recipient's information 36 (to see whether the recipient is in area A or area B), and select, 38, information provider 16 to use to place an advertisement in the web or WAP pages being provided by the Internet service provider (since the resource requirements relating to delivery of information from information provider 16 is only 4 units whereas it is 10 units from information provider 18). The content management system 12 would then embed or otherwise associate this advertisement in the communications to be delivered to the recipient 40, e.g., the web or WAP page, and direct the delivery of the modified communication to the user so that the user receives the requested service and an advertisement 42.

Conversely, when a recipient from area B connects to the Internet service provider, the content management system would select information provider 18 to place an advertisement in the web or WAP pages being provided by the Internet service provider (since resource requirements relating to delivery of information from information provider 18 in this case is only 3 units whereas it is 7 units from information provider 16).

The invention therefore provides a significant benefit by enabling selection of content from a plurality of information providers 16, 18 depending on information about usage of network resources required to deliver the content to the user and/or revenue capable of being generated from the advertisement placement. By contrast, in prior art schemes, only a single information provider could have been selected by the content management system 12 and therefore, there was no means for balancing network resource usage associated with the delivery of content from multiple information providers; as a result, it was highly likely that resource usage was not optimised.

In an alternative embodiment, data about preferences of users for advertisements available from information provider 16 or information provider 18 may be used when selecting which information provider 16 or 18 to use. This data may be either provided by the users themselves or derived from a statistical analysis of users' prior actions. For example, if users have preferences to receive content from information provider 16, or statistically respond better to content from information provider 16, then content management system 12 could be arranged to select content from information provider 16.

A practical application of this embodiment might depend on a preferred search engine selected by each user. Some users might prefer for example Yahoo™ over Google™ or vice versa, and thus an information provider associated with the user's preferred search engine would be selected. The preferred search engine could be either set by the user, provided by the browser of the mobile terminal 14, or be selected by, for example, the operator of the communications network 20 being used by the mobile terminal 14.

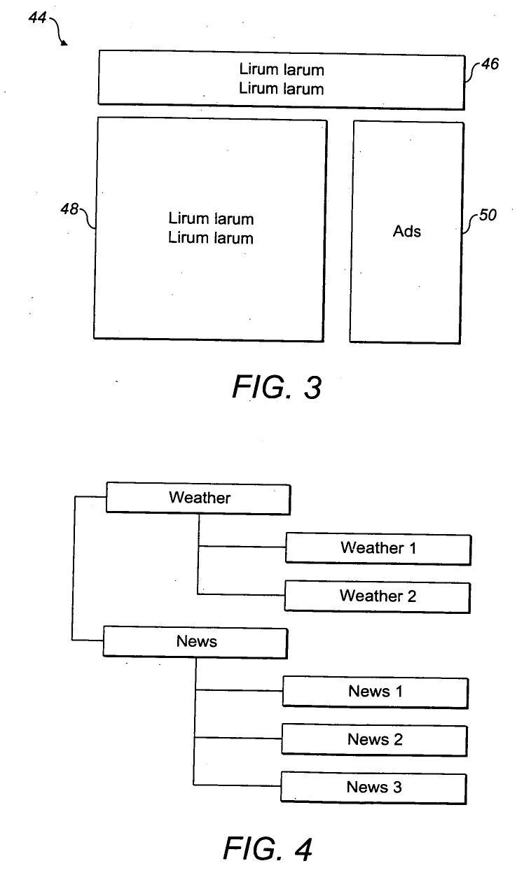

Referring now to FIG. 3, in another example of the system and method for selecting an information provider in accordance with the invention, it will be assumed that a web page 44 is requested by a recipient and includes information content 46, 48 provided by the Internet service provider 28, 30 and one or more spaces allocated to promotional content 50. Implementation of such a page could be done for example using HTML, PHP, ASP, XHTML and other languages. Typically, the web page 44 would have a body and then some kind of link or Java script, or other code, to fetch one or more advertisements to web pages, i.e., links.

One example of implementing this embodiment of the invention would be to have an index.php page with instruction sets to access content management system 12 and return some of the browser parameters such as browser type, IP and the like to the Internet service provider. The content management system 12 would provide instructions to the Internet service provider 28, 30 as to which information provider 16 or 18 to use to access an advertisement.

In one embodiment, the decision about which information provider 16 or 18 to select to obtain an advertisement can be performed by a computer program at the Internet service provider 28, 30. In yet another alternative embodiment, the user's mobile terminal 14 can provide one or more parameters that indicate which information provider 16 or 18 is to be used to receive an advertisement.

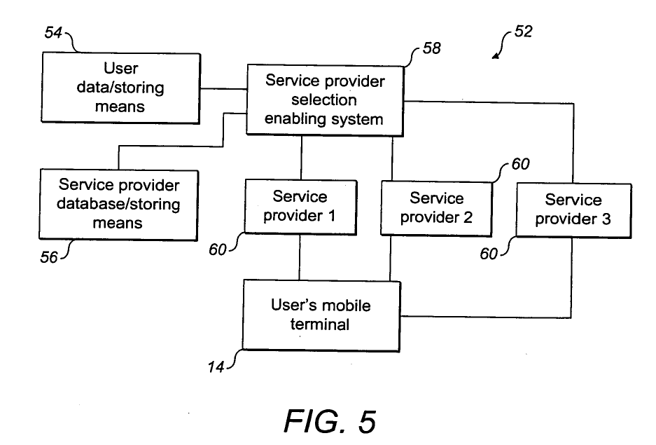

Referring now to FIGS. 4 and 5, in another embodiment of the invention, the content management system 12, instead of determining which advertisement to provide a user, determines which Internet service provider 28 or 30 the user will receive web or WAP pages from. Thus, content management system 12 would more accurately be referred to as a service provider management system 52 (shown in FIG. 5), but would retain the same connections as content management system 12 in FIG. 1. For example, the service provider management system 52 may be arranged to present the user with a page showing links to generic terms such as “Weather”, “News” as shown in FIG. 4 with these links being variable. That is, the links would not be fixed or permanent as in prior art pages wherein a link to “weather” would always link to the same Internet service provider such as CNN Weather or Accuweather.

Rather, in accordance with the invention, the service provider management system 52 sets the actual destination for generically termed links based on information in, provided to and/or accessed by the service provider management system 52. For example, the selection can be performed based on the user's profile or revenue considerations, e.g., which Internet service provider affords the most efficient usage of network resources to the operator of the user's mobile terminal 14 and/or the operator of the service provider management system 52. In addition, if the user is provided with free or subsidized telecommunications services, the selection could consider expected file size of the link to be accessed.

Specifically, as shown in FIG. 4, when the user clicks on the link “Weather”, it could direct the user to “Weather 1” or “Weather 2”, each a distinct Internet service provider 28, 30. In addition, selecting a link “News” could direct the user to “News 1”, “News 2” or “News 3”, again each being a distinct Internet service provider 28, 30.

An exemplifying service provider management system 52 for implementing the above technique of selecting a service provider to provide services to a user upon request is shown in FIG. 5. The determining system 52 includes one or more databases/storing means 54, 56. Database 54 is a user database which stores data relating to the users of the communication network, e.g., a profile of the users and/or a user's preference for a particular type of service provider. Database 56 is a service provider database which stores data about the service providers, such as information about resource usage requirements associated with offering services of the service providers to the users, for example, payment for resource usage paid by the service providers to the operator of the user's mobile terminal 14 to allow the user to receive the service from that service provider. Although database 54, 56 are shown separate from one another, they may be integrated into a single database, or the information therein may be contained in any number of databases.

Whenever a user requests a service via their mobile terminal 14 which can be provided by multiple service providers 60, a service provider selection enabling system 58 communicates with the databases 54, 56, if necessary, and obtains and/or accesses data about the requested service, the user requesting the service and/or about pricing relating to the services provided by the service providers from the databases 54, 56. Determination of a request by the user for services, i.e., clicking on a link identifying a generic term as mentioned above, may be made by the selection enabling system 58.

The selection enabling system 58 then selects one of the service providers 60 to provide the service requested by the user in consideration of the data relating to the user and/or about the service providers from the databases 54, 56. Since the resource usage associated with selecting content from the service providers 60 for the users may be dependent on data relating to the user (due, for example, to the fact that the actual content that any given user can receive might be different), the selection enabling system 58 could select the service provider 60 on the basis of both data relating to the user from database 54 and the potential resource usage associated with the selected service provider from database 56.

The selection enabling system 58 then directs the selected service provider 60, service provider 1, service provider 2 or service provider 3, to provide the requested service to the user's mobile terminal 14. For example, if the requested service is information and service provider 1, service provider 2 and service provider 3 are all capable of providing the information in the form of a web or WAP page, the selection enabling system 58 selects one of these service providers, e.g., service provider 2, and the user is thus presented with the link on their mobile terminal 14 for the web or WAP page of service provider 2. Since different service providers may be selected at different times, e.g., depending on the resource usage agreement, the link to a web or WAP page is therefore varied based on the selected service provider 60.

A computer program to implement the above selection of a service provider upon a request for a service by a user may be embodied on computer-readable media and arranged to interface with the service providers 60 in order to direct them to provide services to users' mobile terminals 14 upon command, e.g., when each is determined to provide the most efficient usage of network resources for the operator of the user's communications network.

The invention enables innovative and focused mobile marketing and advertising. Indeed, the popularity of mobile telephones has enabled their use, along with related infrastructure, as a media for providing mobile marketing, i.e., advertisements to the users of the telephones.

This is important because such a concept is considered by advertisers as the next new channel to directly reach recipients since it utilizes core assets and characteristics of the mobile media, namely, it is personal in that it is directed solely to individual recipients, it is “always on” and can reach recipients whenever they access their communications devices, it is mobile and naturally forms groups of people who communicate actively with each other. These characteristics combined with social networks-based approaches of the Internet form a very powerful base to execute marketing strategies.

In general, mobile marketing and advertising can be divided into the following four categories: mobile marketing, mobile advertising, mobile direct marketing and mobile customer relation management (CRM). The present invention in any of its forms discussed above is applicable to all categories.

Mobile marketing is commonly considered as the systematic planning, implementing and control of a mix of business activities intended to bring together buyers and sellers for the mutually advantageous exchange or transfer of products or services where the primary point of contact with the recipient is via their mobile device.

Mobile advertising is commonly considered as the paid, public, non-personal announcement of a persuasive message by an identified sponsor as well as the non-personal presentation or promotion by a firm of its products to its existing customers and potential customers where such communication is delivered to a mobile telephone or other mobile device. Examples of mobile advertising include: Wireless Application Protocol (WAP) Banner ads, mobile search advertising, mobile video bumpers, and interstitial ads in or on device portals.

Mobile direct marketing is commonly considered a sales and promotion technique in which promotional materials are delivered individually to potential customers via the potential customer's mobile telephone or other mobile device. Examples of mobile direct marketing include the sending of Short Message Service (SMS), Multimedia Message Service (MMS) or Wireless Application Protocol (WAP) push messages, Bluetooth messaging and other interruption-based marketing to mobile telephones or other mobile devices.

Mobile customer relation management is commonly considered as a combination of all the foregoing in a manner that establishes a long-term, engaging relationship between the customer and the marketing or promoting company.

Several computer programs resident on computer-readable media may be used in the invention. One computer program is resident in the content management system 12 and provides advertisements to the communications network 20. Another computer program may be resident in the information providers 16, 18 and manages interaction with advertisers such as reception of advertisements from the advertisers, data about advertising campaigns from the advertisers, receives requests from Internet service providers 28, 30 for advertisements to be associated with communications, e.g., web or WAP pages, being delivered to users' mobile terminals 14, analyzes the requests and provides suitable advertisements, and enables delivery of the advertisements in combination with requested communications to the users' mobile terminals 14.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A system for enabling use of a plurality of information providers in order to obtain content for use by a service provider, each said information provider having access to a plurality of content inventories, each said content inventory being associated with one or more defined characteristics for use in selecting content from a respective inventory, the system comprising:
a content management system arranged to receive, over a data communications network, a request message transmitted from a user terminal, the request message including a request message body identifying a service requested from a service provider, and to obtain data relating to a user of the user terminal and/or relating to resource usage in respect of delivery of content selected by the information providers in response to the receipt of the request message;
said content management system being further arranged to enable selection of one of the information providers to provide content to be associated with the service being requested by the user on the basis of the data relating to the user and/or the information providers,
wherein the content management system is further arranged to generate a further message body associated with the requested service, for transmission via the data communications network, and
wherein the content management system is further arranged to direct the transmission of a response message to the user terminal, the response message comprising activation data arranged to be activated by the user terminal, such activation causing the user terminal to access the requested service and associated content.

2. The system of claim 1, wherein said content management system includes at least one database arranged to store data corresponding to at least one of a user profile, the user's behavior, the user's likelihood of responding to a certain type of content, a user's preference for a particular type of service provider, and a user's assessment of a particular type of content.

3. The system of claim 2, wherein said content management system is arranged to provide the data to the service provider and enable the service provider to select one of the information providers to provide content to be associated with the service being requested by the user on the basis of the data relating to the user and/or the information providers, and obtain content from an inventory associated with the selected information provider.

4. The system of claim 1, wherein said content management system is arranged to provide the data to the service provider and enable the service provider to select one of the information providers to provide content to be associated with the service being requested by the user on the basis of the data relating to the user and/or the information providers, and obtain content from an inventory associated with the selected information provider.

5. The system of claim 4, wherein said content management system is further arranged to select one of the information providers to provide content to be associated with the service being requested by the user on the basis of the data relating to the user and/or the information providers, and to direct the service provider to obtain content from the selected information provider.

6. The system of claim 2, wherein said content management system is further arranged to select one of the information providers to provide content to be associated with the service being requested by the user on the basis of the data relating to the user and/or the information providers, and to direct the service provider to obtain content from the selected information provider.

7. The system of claim 1, wherein said content management system is further arranged to select one of the information providers to provide content to be associated with the service being requested by the user on the basis of the data relating to the user and/or the information providers, and to direct the service provider to obtain content from the selected information provider.

8. The system of claim 1, wherein the information providers have the same or overlapping content inventory.

9. The system of claim 1, wherein the service provider is a provider of mobile services to mobile terminals.

10. The system of claim 2, wherein the system further comprising an interface provided by each of the information providers which enables reservation of a content delivery campaign with the information provider and on the basis of specified preferences relating to the delivery of the content.

11. The system of claim 1, wherein the system further comprising an interface provided by each of the information providers which enables reservation of a content delivery campaign with the information provider and on the basis of specified preferences relating to the delivery of the content

12. The system of claim 11, further comprising at least one database for storing the content and said delivery preferences.

13. The system of claim 10, further comprising at least one database for storing the content and said delivery preferences.

14. The system of claim 11, further comprising a respective database associated with each information provider for storing content and preferences for use by the information provider.

15. The system of claim 10, further comprising a respective database associated with each information provider for storing content and preferences for use by the information provider.

16. The system of claim 1, wherein said content management system is arranged to obtain data relating to resource requirements associated with content provided by the information providers, said resource requirements including resource usage by association of content with the requested service, and the content management system is further arranged to enable selection of one of the information providers to provide content to be associated with the service being requested by the user on the basis of the associated resource usage requirements.

17. The system of claim 16, wherein the data relating to resource usage associated with content is dependent on data relating to the user, said content management system being arranged to enable selection of one of the information providers to provide content to be associated with the service being requested by the user on the basis of both data relating to the user and the resource usage required by association of the content.

18. The system of claim 1, wherein the requested service is a web or WAP page including at least one portion for content, said content management system being arranged to enable insertion of a content into each of the at least one portion such that a modified web or WAP page is deliverable to the user including the original web or WAP page and a content.

19. The system of claim 15, the system further comprising:
a storage system for storing data relating to users of terminals and/or relating to resource requirements associated with content provided by the information providers; and
means for determining that a user of the user terminal is requesting a service from the service provider.

20. The system of claim 14, the system further comprising:
a storage system for storing data relating to users of terminals and/or relating to resource requirements associated with content provided by the information providers; and
means for determining that a user of the user terminal is requesting a service from the service provider.

21. The system of claim 13, the system further comprising:
a storage system for storing data relating to users of terminals and/or relating to resource requirements associated with content provided by the information providers; and
means for determining that a user of the user terminal is requesting a service from the service provider.

22. The system of claim 12, the system further comprising:
a storage system for storing data relating to users of terminals and/or relating to resource requirements associated with content provided by the information providers; and
means for determining that a user of the user terminal is requesting a service from the service provider.

23. The system of claim 11, the system further comprising:
a storage system for storing data relating to users of terminals and/or relating to resource requirements associated with content provided by the information providers; and
means for determining that a user of the user terminal is requesting a service from the service provider.

24. The system of claim 10, the system further comprising:
a storage system for storing data relating to users of terminals and/or relating to resource requirements associated with content provided by the information providers; and
means for determining that a user of the user terminal is requesting a service from the service provider.

25. The system of claim 2, the system further comprising:
a storage system for storing data relating to users of terminals and/or relating to resource requirements associated with content provided by the information providers; and
means for determining that a user of the user terminal is requesting a service from the service provider.

26. The system of claim 1, the system further comprising:
a storage system for storing data relating to users of terminals and/or relating to resource requirements associated with content provided by the information providers; and
means for determining that a user of the user terminal is requesting a service from the service provider.

27. A method for enabling use of a plurality of information providers in order to obtain content for use by a service provider, each said information provider having access to a plurality of content inventories, each said content inventory being associated with one or more defined characteristics for use in selecting content from a respective inventory, the method comprising:
receiving, over a data communications network, a request message transmitted from a user terminal, the request message including a request message body identifying a service requested from a service provider;
obtaining data relating to a user of the user terminal and/or relating to resource requirements relating to content provided by the information providers in response to the receipt of the request message;
selecting one of the information providers to provide content to be associated with the service being requested by the user in consideration of the data relating to the user and/or the information providers;
generating a further message body associated with the requested service, for transmission via the data communications network; and
directing the transmission of a response message to the user terminal, the response message comprising activation data arranged to be activated by the user terminal, such activation causing the user terminal to access the requested service and associated content.

28. The method of claim 27, further comprising:
providing the content from the selected one of the information providers to the service provider; and
associating the content into the service being provided by the service provider.

29. The method of claim 28, further comprising delivering the service with associated content to the user.

30. The method of claim 27, further comprising delivering the service with associated content to the user.

31. The method of claim 27, wherein the service provider is an Internet service provider and the service is a web or WAP page which is deliverable to the user's mobile terminal.

32. The method of claim 27, wherein the selection of one of the information providers is performed by the service provider.

33. The method of claim 30, further comprising enabling reservation of a content delivery campaign with the information provider and provision of preferences relating to the delivery of the content.

34. The method of claim 29, further comprising enabling reservation of a content delivery campaign with the information provider and provision of preferences relating to the delivery of the content.

35. The method of claim 28, further comprising enabling reservation of a content delivery campaign with the information provider and provision of preferences relating to the delivery of the content.

36. The method of claim 27, further comprising enabling reservation of a content delivery campaign with the information provider and provision of preferences relating to the delivery of the content.

37. The method of claim 27, wherein the requested service is a web or WAP page including at least one portion for a content, the method further comprising inserting content from the selected information provider into each of the at least one portion such that a modified web or WAP page is deliverable to the user including the original web or WAP page and content.

38. A computer program, or a suite of computer programs, comprising a set of executable instructions resident on computer-readable media for enabling use of a plurality of information providers in order to obtain content for use by a service provider, each said information provider having access to a plurality of content inventories, each said content inventory being associated with one or more defined characteristic for use in selecting content from a respective inventory, and arranged to:
receive, over a data communications network, a request message transmitted from a user terminal, the request message including a request message body identifying a service requested from a service provider;
obtain data relating to a user of the user terminal and/or relating to resource requirements relating to content provided by the information providers in response to the receipt of the request message;
select one of the information providers to provide content to be associated with the service being requested by the user in consideration of the data relating to the user and/or the information providers;
generate a further message body associated with the requested service, for transmission via the data communications network; and
direct the transmission of a response message to the user terminal, the response message comprising activation data arranged to be activated by the user terminal, such activation causing the user terminal to access the requested service and associated content.

39. The computer program of claim 38, wherein the computer program or suite of computer programs is further arranged to:
provide the content from the selected one of the information providers to the service provider; and
associate the content into the service being provided by the service provider.

40. The computer program of claim 39, wherein the computer program or suite of computer programs is further arranged to deliver the service with associated content to the user.

41. The computer program of claim 38, wherein the computer program or suite of computer programs is further arranged to deliver the service with associated content to the user.

42. The computer program of claim 38, wherein the service provider is an Internet service provider and the service is a web or WAP page which is deliverable to the user's mobile terminal.

43. The computer program of claim 38, wherein the selection of one of the information providers is performed by the service provider.

44. The computer program of claim 41, wherein the computer program or suite of computer programs is further arranged to enable reservation of a content delivery campaign with the information provider and provision of preferences relating to the delivery of the content.

45. The computer program claim 40, wherein the computer program or suite of computer programs is further arranged to enable reservation of a content delivery campaign with the information provider and provision of preferences relating to the delivery of the content.

46. The computer program of claim 39, wherein the computer program or suite of computer programs is further arranged to enable reservation of a content delivery campaign with the information provider and provision of preferences relating to the delivery of the content.

47. The computer program of claim 38, wherein the computer program or suite of computer programs is further arranged to enable reservation of a content delivery campaign with the information provider and provision of preferences relating to the delivery of the content.

48. The computer program of claim 38, wherein the requested service is a web or WAP page including at least one portion for a content, the method further comprising inserting content from the selected information provider into each of the at least one portion such that a modified web or WAP page is deliverable to the user including the original web or WAP page and content.

49. A system for enabling use of a plurality of internet service providers in order to provide web-based services to users, the system comprising:
a management system arranged to receive, over a data communications network, a request message transmitted from a user terminal, the request message including a request message body identifying a requested service, and to obtain data about a user of the user terminal and/or about resource requirements relating to the services provided by the internet service providers in response to the receipt of the request message;
said management system being further arranged to enable selection of one of the internet service providers to provide a service to the user in consideration of the data relating to the user and/or the internet service providers,
wherein the management system is further arranged to generate a further message body associated with the requested service, for transmission via the data communications network, and
wherein the management system is further arranged to direct the transmission of a response message to the user terminal, the response message comprising activation data arranged to be activated by the user terminal, such activation causing the user terminal to access the selected internet service provider and associated requested service.

50. The system of claim 49, wherein the requested service comprises an information service and the internet service providers are capable of providing the information in the form of a web or WAP page, the user being presented with the link for the web or WAP page of the selected one of the internet service providers.

51. The system of claim 50, wherein said management system is arranged to direct a selectable link to the user to enable the user to obtain the requested service from the selected one of the internet service providers, the link being varied based on the selected one of the internet service providers.

52. The system of claim 49, wherein said management system is arranged to direct a selectable link to the user to enable the user to obtain the requested service from the selected one of the internet service providers, the link being varied based on the selected one of the internet service providers.

53. The system of claim 49, wherein said management system includes at least one database which stores data corresponding to at least one of a user profile and a user's preference for a particular type of internet service provider.

54. The system of claim 49, wherein said management system is arranged to obtain data relating to resource usage associated with provision of services by the internet service providers to the users, the management system being further arranged to enable selection of one of the internet service providers to provide the requested services to the user on the basis of the resource usage requirements associated with provision of the requested service by the selected internet service provider.

55. The system of claim 54, wherein the resource usage requirements are dependent on data relating to the users, said management system thus being arranged to enable selection of one of the internet service providers to provide the requested service to the user on the basis of both data relating to the user and the resource usage requirements associated with provision of the requested service by the selected internet service provider.

56. The system of claim 49, wherein said management system is further arranged to obtain data relating to a file size corresponding to a link to be provided by each of the internet service providers to the user to enable the user to obtain the requested service and to select one of the internet service providers to provide the requested service on the basis of the resource usage requirements associated with accessing the link, which resource usage requirements vary as a function of the file size of the link.

57. The system of claim 53, the system comprising:
a storage system arranged to store data relating to users of terminals and/or relating to resource requirements associated with services provided by the internet service providers in response to the receipt of the request message;
means for determining that a user of the user terminal is requesting a service from an internet service provider.

58. The system of claim 52, the system comprising:
a storage system arranged to store data relating to users of terminals and/or relating to resource requirements associated with services provided by the internet service providers in response to the receipt of the request message;
means for determining that a user of the user terminal is requesting a service from an internet service provider.

59. The system of claim 51, the system comprising:
a storage system arranged to store data relating to users of terminals and/or relating to resource requirements associated with services provided by the internet service providers in response to the receipt of the request message;
means for determining that a user of the user terminal is requesting a service from an internet service provider.

60. The system of claim 50, the system comprising:
a storage system arranged to store data relating to users of terminals and/or relating to resource requirements associated with services provided by the internet service providers in response to the receipt of the request message;
means for determining that a user of the user terminal is requesting a service from an internet service provider.

61. The system of claim 49, the system comprising:
a storage system arranged to store data relating to users of terminals and/or relating to resource requirements associated with services provided by the internet service providers in response to the receipt of the request message;
means for determining that a user of the user terminal is requesting a service from an internet service provider.

62. A method for enabling use of a plurality of internet service providers in order to provide services to users, the method comprising:
receiving, over a data communications network, a request message transmitted from a user terminal, the request message including a request message body identifying a requested service;
obtaining data relating to a user of the user terminal and/or relating to resource requirements relating to the services provided by the internet service providers in response to the receipt of the request message;
selecting one of the internet service providers to provide a service to the user in consideration of the data relating to the user and/or the internet service providers;
generating a further message body associated with the requested service, for transmission via the data communications network; and
directing the transmission of a response message to the user terminal, the response message comprising activation data arranged to be activated by the user terminal, such activation causing the user terminal to access the selected internet service provider and associated requested service.

63. The method of claim 62, wherein the requested service comprises an information service and the internet service providers are capable of providing the information in the form of a web or WAP page, further comprising presenting the user with a link for the web or WAP page of the selected one of the internet service providers.

64. The method of claim 63, further comprising:
providing the user with a selectable link for use in enabling the user to obtain the requested service from the selected one of the internet service providers; and
varying the link based on the selected one of the internet service providers.

65. The method of claim 30, further comprising:
providing the user with a selectable link for use in enabling the user to obtain the requested service from the selected one of the internet service providers; and
varying the link based on the selected one of the internet service providers.

66. The method of claim 65, wherein the step of selecting one of the internet service providers comprises selecting one of the internet service providers on the basis of resource usage requirements associated with provision of services from the selected internet service provider.

67. The method of claim 64, wherein the step of selecting one of the internet service providers comprises selecting one of the internet service providers on the basis of resource usage requirements associated with provision of services from the selected internet service provider.

68. The method of claim 67, wherein the resource usage requirements are dependent on data relating to the user, and the step of selecting one of the internet service providers comprises selecting one of the internet service providers to provide the requested service to the user on the basis of both data relating to the user and resource usage requirements associated with provision of services from the selected internet service provider.

69. The method of claim 66, wherein the resource usage requirements are dependent on data relating to the user, and the step of selecting one of the internet service providers comprises selecting one of the internet service providers to provide the requested service to the user on the basis of both data relating to the user and resource usage requirements associated with provision of services from the selected internet service provider.

70. The method of claim 69, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

71. The method of claim 68, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

72. The method of claim 67, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

73. The method of claim 66, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

74. The method of claim 65, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

75. The method of claim 64, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

76. The method of claim 63, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

77. The method of claim 62, further comprising obtaining data relating to a file size of a link to be provided by each of the internet service providers to the user to enable the user to obtain the requested service, the step of selecting one of the service providers comprising selecting one of the service providers to provide the requested service to the user in consideration of the resource usage requirements associated with the user accessing the link, which resource usage requirements vary as a function of the file size of the link.

78. A computer program, or a suite of computer programs, comprising a set of executable instructions resident on computer-readable media for enabling use of a plurality of internet services providers in order to provide services to users, and being arranged to:
receive, over a data communications network, a request message transmitted from a user terminal, the request message including a request message body identifying a requested service;
obtain data relating to a user of the user terminal and/or relating to resource requirements relating to the services provided by the internet service providers in response to the receipt of the request message;
select one of the internet service providers to provide a service to the user in consideration of the data relating to the user and/or the internet service providers;
generate a further message body associated with the requested service, for transmission via the data communications network; and
direct the transmission of a response message to the user terminal, the response message comprising activation data arranged to be activated by the user terminal, such activation causing the user terminal to access the selected internet service provider and associated requested service.

79. The computer program or suite of computer programs of claim 78, wherein the requested service comprises an information service and the internet service providers are capable of providing the information in the form of a web or WAP page, the computer program or suite of computer programs being further arranged to present the user with a link for the web or WAP page of the selected one of the internet service providers.

80. The computer program or suite of computer programs of claim 78, wherein the computer program or suite of computer programs is further arranged to:
provide the user with a selectable link for use in enabling the user to obtain the requested service from the selected one of the internet service providers; and
vary the link based on the selected one of the internet service providers.

81. The computer program or suite of computer programs of claim 78, wherein selecting one of the internet service providers comprises selecting one of the internet service providers on the basis of resource usage requirements associated with provision of services from the selected internet service provider.

82. The computer program or suite of computer programs of claim 78, wherein the resource usage requirements are dependent on data relating to the user, and selecting one of the internet service providers comprises selecting one of the internet service providers to provide the requested service to the user on the basis of both data relating to the user and resource usage requirements associated with provision of services from the selected internet service provider.

83. The computer program or suite of computer programs of claim 78, wherein the computer program or suite of computer programs is further arranged to obtain data relating to a file size of a link to be provided by each of the internet service providers to the user to enable the user to obtain the requested service, and selecting one of the service providers comprises selecting a service provider to provide the requested service to the user in consideration of the resource usage requirements associated with the user accessing the link, which resource usage requirements vary as a function of the file size of the link.

84. A computer-readable medium having stored thereon computer executable instructions which when executed by a computer performs:
receiving, over a data communications network, a request message transmitted from a user terminal, the request message including a request message body identifying a requested service;
obtaining data relating to a user of the user terminal and/or relating to resource requirements relating to the services provided by the internet service providers in response to the receipt of the request message;
selecting one of the internet service providers to provide a service to the user in consideration of the data relating to the user and/or the internet service providers;
generating a further message body associated with the requested service, for transmission via the data communications network; and
directing the transmission of a response message to the user terminal, the response message comprising activation data arranged to be activated by the user terminal, such activation causing the user terminal to access the selected internet service provider and associated requested service.

85. The computer-readable medium of claim 84, wherein the requested service comprises an information service and the internet service providers are capable of providing the information in the form of a web or WAP page, the computer-readable medium having stored thereon computer executable instructions which when executed by the computer further performs presenting the user with a link for the web or WAP page of the selected one of the internet service providers.

86. The computer-readable medium of claim 84, the computer-readable medium having stored thereon computer executable instructions which when executed by the computer further performs:
providing the user with a selectable link for use in enabling the user to obtain the requested service from the selected one of the internet service providers; and
varying the link based on the selected one of the internet service providers.

87. The computer-readable medium of claim 84, wherein selecting one of the internet service providers comprises selecting one of the internet service providers on the basis of resource usage requirements associated with provision of services from the selected internet service provider.

88. The computer-readable medium of claim 84, wherein the resource usage requirements are dependent on data relating to the user, and selecting one of the internet service providers comprises selecting one of the internet service providers to provide the requested service to the user on the basis of both data relating to the user and resource usage requirements associated with provision of services from the selected internet service provider.

89. The computer-readable medium of claim 84, the computer-readable medium having stored thereon computer executable instructions which when executed by the computer further performs obtaining data relating to a file size of a link to be provided by each of the internet service providers to the user to enable the user to obtain the requested service, and selecting one of the service providers to provide the requested service to the user in consideration of the resource usage requirements associated with the user accessing the link, which resource usage requirements vary as a function of the file size of the link.
